(19) United States
(12) Patent Application Publication
(10) Pub. No.: US 2007/0278761 A1
(43) Pub. Date: Dec. 6, 2007

(54) Wheelchair with elevating seat

(76) Inventor: Charles Basil Firth, Newcastle-upon-Tyne (GB)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 11/805,852

(22) Filed: May 24, 2007

(30) Foreign Application Priority Data
May 24, 2006 (GB) GB0610313.9

(51) Int. Cl. B62M 1/14

(52) U.S. Cl. 280/250.1

(57) ABSTRACT

A wheelchair includes a frame, a seat and apparatus for moving the seat between lowered and raised positions, the apparatus comprising a translating mechanism having a first end and a second end. The translating mechanism is attached to the frame and the seat is attached to the second end of the translating mechanism, and the translating mechanism generates a translational movement of the seat that is forwards and upwards with respect to the frame. The apparatus further comprises assist means, wherein the said assist means generates a force component substantially parallel to the direction of translation of the said seat, to move the seat from the lowered to the raised position. The seat is a saddle seat and in the lowered position an occupant is in a seated position and in the raised position the occupant is in a mounted stance with a major part of said occupant's weight reacted through the seat, and wherein the translating mechanism comprises a four bar linkage, the seat and the frame being attached to respective ends of the four bar linkage.

### CROSS-REFERENCE TO RELATED APPLICATION(S)

This application claims priority of United Kingdom Application No. GB0610313.9 filed May 24, 2006.

### BACKGROUND

This invention relates to a wheelchair with an elevating seat, and in particular to a mechanism providing for the selective positioning and suspension of a seat on a wheelchair.

Wheelchairs can be highly manoeuvrable. They allow their users to do most of the things that one would normally do when seated and can be readily propelled at a similar speed that an able bodied person might travel at when walking. They can also offer a comfortable ride when used on smooth surfaces.

Whilst they allow their users to do most of the things that others might do whilst sitting down, they do not usually enable the users to do things that others might do if standing up. This is because the upper body is nearly always at a lower level when sitting down when compared to when standing up.

Whilst they offer a comfortable ride when used on smooth surfaces, when used on bumpy surfaces they can be very uncomfortable.

The world is designed around the fact that people usually stand up to do some things and sit down to do others. There are many situations where a wheelchair user would benefit from being at the same height that he might be if standing up.

Wheelchairs that enable the user to interact at an elevated height are well known in the art.

Wheelchairs that incorporate stand-up mechanisms, or mechanisms that allow for positioning of the seat in an elevated position, thus enabling users to interact at an increased height, have been proposed.

Such wheelchairs incorporating stand up mechanisms work by clamping the legs and body of the user to a structural framework. The framework is designed to pivot in the axes as the knee and the hip of the user and works by moving the framework and the body clamped to it from the seated to a standing position. In the standing position the weight of the user is supported by the bones and or muscles in the legs and is reacted through the feet. For acceptable stability in the standing position, the body is often arranged to be inclined back against the frame which is an unnatural stance. A further feature of stand-up wheelchairs is that the centre of gravity of the user on the wheelchair is significantly further forward than when in the seated position. This makes the user much less stable when in the standing position to such an extent that secondary means of providing stability is often required.

Wheel chairs with elevating seats are nearly always powered. They often require heavy mechanisms such as gearboxes and or electric actuating motors which in turn require batteries such that the weight of the wheelchair increases and it becomes expensive and more limited in its versatility. If electric motors and batteries are not used the actuation must be achieved by the user. This requires a separate mechanism and a substantial amount of energy to effect the translation.

One such device, described in U.S. Pat. No. 5,108,202 (Smith), incorporates a hydraulic cylinder and a manually operated hydraulic pump assembly to raise the chair to a height where the user's body is at the height that it might be if he was standing.

Another feature of known designs is that the change in energy of the user as he lowers himself from the elevated position to the seated position is lost.

Another feature of standard wheelchairs is that they normally rely on the flexing of the tyres and the seat cushion for suspension. They do not usually have any other type of suspension. It would be desirable to have improved suspension on a wheelchair to improve the comfort of the user when travelling over uneven ground.

It would therefore be desirable to develop a wheelchair with an elevating seat that does not suffer from the disadvantages associated with the above-described prior art devices.

### SUMMARY

According to one aspect of the invention there is provided apparatus for moving a seat of a wheelchair between lowered and raised positions as specified in Claim 1.

According to another aspect of the invention there is provided a wheelchair as specified in Claim 20.

The present invention overcomes the limitations of the existing devices by providing a wheelchair with a seat attached to a frame and connected to another frame using a lightweight mechanism that provides a suspension for the seat when in the down position and also allows the user to move quickly and easily to and from an elevated height. At the elevated height the user adopts a “mounted” stance on a saddle type seat.

When seated, the upper leg (the femur) lies generally horizontally whilst the lower leg (the tibia) lies vertically. It is desirable that the translating mechanism connecting the seat and the frame is such that the seat is elevated to a position that orients the femur at a comfortable angle of approximately 45 degrees to the horizontal, whilst keeping the tibia generally vertical. The geometric requirements to create this feature are such that the position of the seat must be translated forward as well as vertically upward. The seat should not rotate as it moves.

In order to keep the tibia in the same position during the transition from seated to mounted stance, it would be necessary effectively pivot the femur about the pivot axis of the knees.

This simultaneous forward and upward motion may be conveniently achieved by connecting the seat to the framework of the wheelchair using a four bar linkage. This four bar linkage may also be a parallel linkage. The stat frame and wheelchair frame are connected together using a top link and a bottom link.

The preferred position of the seat in the raised position is forward by a distance equivalent to approximately 35% of the vertical change in height.

To achieve this motion the top link and bottom links lie parallel to each other. With the seat in the down position the top and bottom links lie generally horizontally. When the seat is in the raised position the top and bottom links lie at an angle of approximately 45 degrees to the horizontal. The bars, i.e. the frames, to which the top and bottom links are connected to remain at substantially the same inclination.

In order to enable the user to effect the translation of the seat relative to the frame with the linkage, a translating force, generally parallel with the direction of movement is required. This force is provided by the user as he pushes down on the arm rests with his hands and an assisting component provided by an assisting mechanism.

The assisting component is provided by the effect of two gas struts connected between the frame of the wheelchair and the top link of the four bar linkage.

A known feature of gas struts is that the force they react decreases as they extend and it would be highly desirable to achieve a substantially constant force as the seat is lifted.

The fixing position of the gas strut must therefore be carefully selected.

It is desirable that the gas struts are pivotally mounted close to the centre line drawn between the pivots of the ends of the top link at one of their ends and pivotally mounted at their other end onto the framework so that the gas struts lie at an angle of between 70 and 105 degrees away from a line drawn between the pivot points of the top link.

In FIG. 3, the vertical component of the force provided by the gas strut at the end of the top link that attaches to the seat frame is shown for the seat at different heights. The arrangement is such that the vertical component of the force provided by the gas struts, to support the weight of the user on the seat, is greater when the seat and seat frame are in the up position compared to when in the down position.

With the seat in the down position, the weight of the user, supported by the seat combined with the weight of the seat and associated linkage, may be greater than the vertical force component provided by the gas struts.

With this arrangement, in order to effect the translation from seated to mounted stance, the user provides an actuating force, usually by pushing down on the frame, a component of which must be parallel to the direction of the movement, of a magnitude such that together with the assisting force, the combination overcomes the component of the weight parallel to the direction of translation. Thus, for example, where the component of the weight supported by the mechanism parallel to the direction of motion is say 700 Newtons, the assisting mechanism could provide a force of say 650 Newtons and the user marginally in excess of 50N in order to effect the translation. Thus a relatively low force is required from the user to translate from the seated to mounted stance.

In the elevated position the vertical component of the force provided by the gas strut is greater than the sum of the effective weight of the user on the seat, the seat and its associated linkage. In this way it is not necessary for the user to constantly apply a force against the arm rests or frame to keep the seat in the elevated position.

For additional safety, once the translation has been effected, a catch may engage to secure the seat in the elevated position.

In order to move from the mounted to the seated stance, the user releases the catch (if fitted) and pulls down on the frame using his hands and arms. The force created by this pulling, coupled with the weight acting on the linkage, makes the gas struts retract and the seat and user lower to the seated position. The gas struts serve to provide a smooth slower translation than would have been experienced if the gas struts were not there, and also serve to collect a substantial amount of the potential energy of the mass of the user, seat and structure as it falls. The energy is collected and stored in the form of compressed gas in the gas struts. This energy is used to assist the lift motion next time the chair needs to be elevated.

In the seated position a catch engages to ensure that the lift mechanism does not actuate as the weight of the user is removed from the seat as the user gets out of the chair. To move from the seated to the mounted position, the user must release the catch. This can only be done if the force on the seat is sufficient to unload the catch. The user provides sufficient force by sitting on the seat and pulling down on the frame if necessary, to allow the catch to rotate freely.

With the catch released, the user pushes down on the framework thus providing sufficient force, coupled with the force from the gas struts, to allow the linkage to rotate to effect the translation from seated to mounted position.

The arrangement is such that the catch cannot be released unless the total force acting on the seat is greater than the effect of the reacting force provided by the gas spring. Effectively the catch works to hold the seat in the seated position with or without the user, but can only be released when the user is correctly sitting on the seat. The catch works by restraining the top link relative to the framework.

The seat is configured so that the user can comfortably use it with his or her femur oriented at an angle between at least horizontal and at least 45 degrees up from the horizontal. This type of seat is known as a saddle seat.

As the mechanism of the invention allows the user to quickly and easily raise and lower himself to and from the two positions with minimal effort, it is very convenient for the user to raise himself whenever he needs to perform a task at an elevated height and then to lower himself quickly and conveniently back to the seated position in which configuration the wheelchair can be manoeuvred like other wheelchairs. In the seated position, the stability of the wheelchair of the invention is comparable with that of conventional wheelchairs.

In the mounted stance the majority of the weight of the user is reacted through the saddle type seat whilst the legs are bent making it easier for the user to get closer to people and objects.

It is highly desirable that a wheelchair of the type described should be made available to as large number of people as possible. A variety of different users are statistically likely to have different weights in the range say between say 50 KG and 100 KG. Each user would require differing levels of assisting force to enable the user to effect the translation using a relatively small additional force. The level of the assist force would therefore be different for users of different weight. It would be possible to provide a set of gas struts charged to the appropriate pressure for each different user, however it is more desirable to have a smaller number of gas struts and a means to adjust their effect. In order to reduce the number of gas struts required for a variety of different users, means is provided to adjust the effective mounting position of the gas strut on the top link of the mechanism. This may be done by providing a number of alternative mounting holes on the top link. It could also be done by providing an adjustable means on the top link, for example a sliding mechanism may be attached to the top link and the end of the gas strut attached to the sliding element of the said mechanism.

Saddle seats are characterised in that they are designed for use with the femur lying at an angle down from the vertical. With the saddle seat in the up position in the arrangement described, the femur lies down from the vertical, but when the saddle seat is in the down position, the femur lies approximately horizontally. With the seat in the down position it would be desirable to have additional support for the upper legs of the user, but such support would not be desirable with the seat in the up position. In order to achieve this therefore, leg supports may be provided that provide support when the seat is down, and do not provide support when the seat is raised. This may be achieved by attaching the leg support to the top link of the four bar linkage.

When using wheelchairs over surfaces that are not perfectly smooth, such as pavements where the flag stones have become loose or misaligned, wheelchairs and their users experience accelerations that make the ride uncomfortable. The tyres of the wheelchair provide a suspension effect, but for reduced rolling resistance, it is desirable to inflate the tires to a high pressure. At high inflation pressures tyres do not provide comfortable suspension.

It is therefore desirable to have additional more effective suspension. The four bar linkage mechanism therefore is arranged to provide suspension for the seat and rider. The travel provided by the linkage as it moves against the catch provides the translation. This may provide movement of about 30 mm. The damping and spring effect of the suspension is provided for by the gas springs.

It is also possible to prevent the seat from lifting when the rider gets off the wheelchair by locking the seat or the bracket on which the seat is fixed, relative to the top link. This feature is readily provided by a sliding latch arrangement. This arrangement can be used to act as a secondary safety lock to prevent the wheelchair seat from lifting if the catch is accidentally operated or fails.

### BRIEF DESCRIPTION OF THE DRAWINGS

In the drawings, which illustrate by way of example one embodiment of a wheelchair with an elevating seat according to the invention:

FIG. 1 shows a wheelchair with the seat in the lowered position in which the user adopts the “seated” stance;

FIG. 2 shows the wheelchair with the sear in the elevated position in which the user adopts the “mounted” stance;

FIG. 3 is a graph indicating the forces induced in the lifting action;

FIG. 4 is a plan view of the wheelchair illustrated in FIGS. 1 and 2;

FIG. 5 is a side view of a wheelchair with the seat in the lowered position and illustrating a safety lock; and

FIGS. 6a to 6c illustrate a latch mechanism in three different states.

### DETAILED DESCRIPTION

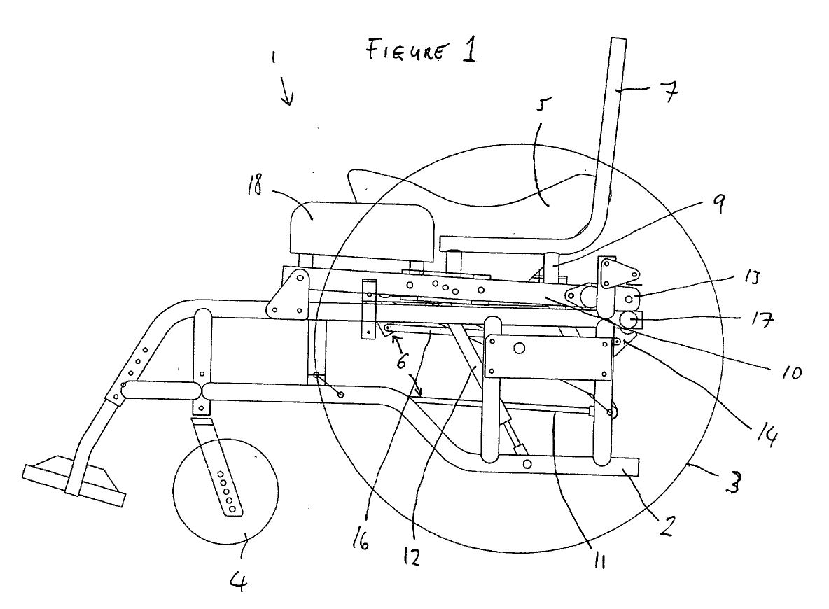

Referring now to FIG. 1, a wheelchair (1) comprises a frame (2). To the rear of the frame (2) are mounted a pair of large diameter spaced apart wheels (3), each wheel of the pair being mounted on a respective side of the frame (2). To the front of the frame (2) is mounted a pair of small diameter wheels (4), each wheel of the pair being mounted on a respective side of the frame (2).

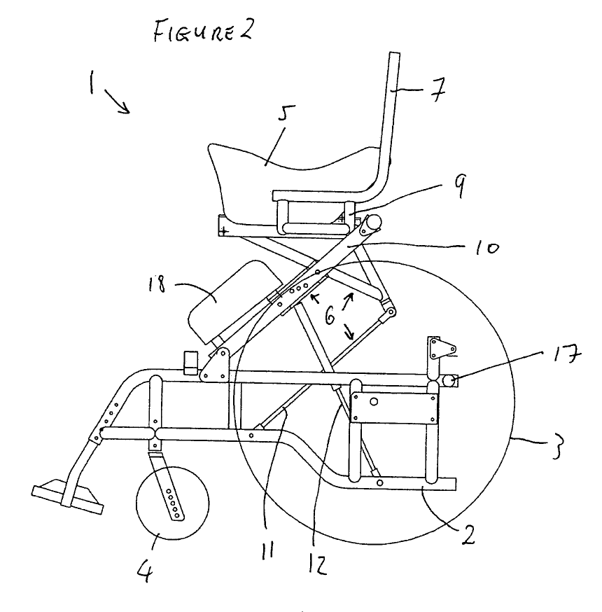

A saddle type seat (referred to hereafter as “a seat”) (5) is mounted on the frame (2) by means of a translating mechanism (6). To the rear of the saddle type seat (5) is a back rest (7). It can be seen from FIG. 2 that the backrest (7) moves with the saddle type seat (5) when the said seat moves into an elevated position.

The frame 2 may also mount side guards located to either side of the seat 5. Such guards have a number of purposes. For example, the side guards provide an object against which a person sitting in the wheelchair can push against to raise himself to the standing position. They also protect a person sitting in the wheelchair from the wheels 3. Side guards are a common feature of wheelchairs and as such for the sake of clarity are not shown in the drawings.

The translating mechanism comprises a four bar linkage which may also be a parallel linkage. The first bar is provided by the framework (2), the second by the seat bracket (9), the third by the top link (10) and the fourth by the bottom link (11). The saddle seat (5) and back rest (7) are attached to the seat bracket (9).

The bars are pivotably connected to each other. The top and bottom link are each connected to the seat frame and the framework.

Assist means, which in the example are in the form of gas struts (12), are connected between the top link (10) and the frame (2). In order to provided for a gas strut to provide a lifting force matched to individuals having different weights, the top link is provided with a plurality of attachment points (12a), (12b) and (12c) for attachment of the gas struts (12) to the top link. Each of the attachment points (12a) to (12c) lies on a common radius centred at the attachment point of the gas strut (12) to the frame (2). It will be understood that one attachment point may be provided on the top link (10) and a plurality of attachment points provided on the frame (2) and the same result achieved. Further, respective ends of the gas struts may be attached to the frame (2) and any movable link of the four bar linkage, or a part attached to a movable link of the four bar linkage, such as the seat attachment.

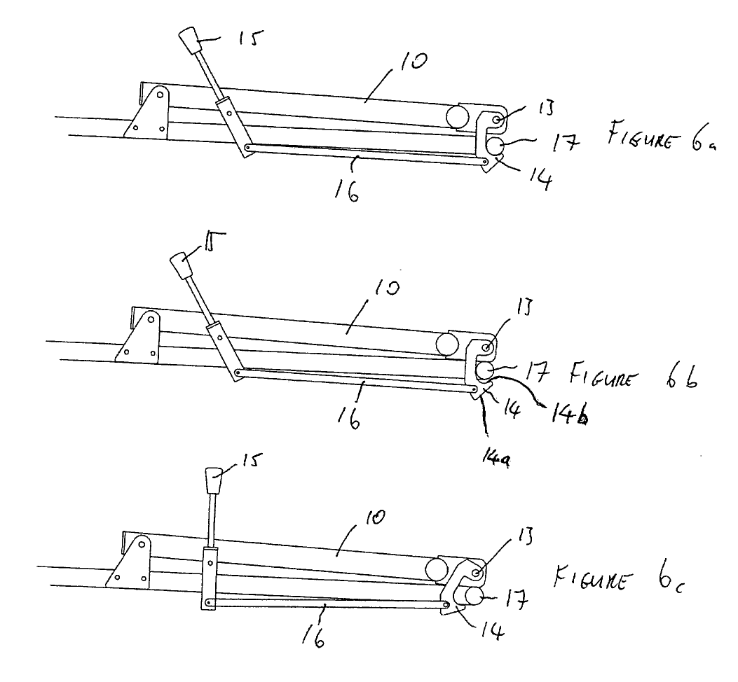

Referring now to FIGS. 6a to 6c, the top link is provided with a lug (13) that provides the pivotal support for the catch plate (14). The catch plate is free to rotate about its pivot. The surface of the catch plate (14) is profiled (14a) so that as the top link (10) rotates towards the frame (2), the catch plate (14) rotates as it engages with one of the cross members (17) of the frame (2), in such a way that a hook surface 14b hooks over the cross member (17) when the top link is close to the frame (2). The catch plate (14) may be biased to pivot towards the position illustrated in FIGS. 6a to 6c.

The arrangement is such that the catch plate (14) restrains the top link (10) relative to the frame (2).

A release handle (15) is pivotally mounted onto the seat frame (9) close to the front of the seat where it can be readily accessed by the rider. The release handle (15) is connected to the catch plate (14) with a tie rod (16) in such a way so that when the release handle (15) is rotated about its pivot, the catch plate (14) is caused to rotate so that the hook surface of the catch plate (14) is free from the cross member (17) on the frame (2) and the top link (10) is then free to rotate to lift the seat on its frame (9).

In FIG. 6a, the seat (5) is unoccupied and the force exerted by the gas struts (12) force the catch plate (14) into engagement with the cross member (17). In FIG. 6b, the seat (5) is occupied, the additional weight of the user or the additional weight of the occupant plus a downward force exerted by the occupant on the frame of the wheelchair moves the top link (10) downward causing the catch plate (14) to be clear of the cross member (17). FIG. 6c illustrates the position occupied by the catch plate (14) when the lever (15) has been pulled backwards to release the catch plate 14. With the lever in the position illustrated in FIG. 6c, the occupant of the seat (5) is free to move between the lowered and raised positions illustrated in FIGS. 1 and 2 respectively.

The arrangement illustrated in FIGS. 6a to 6c ensures that the unoccupied seat remains in the lowered position.

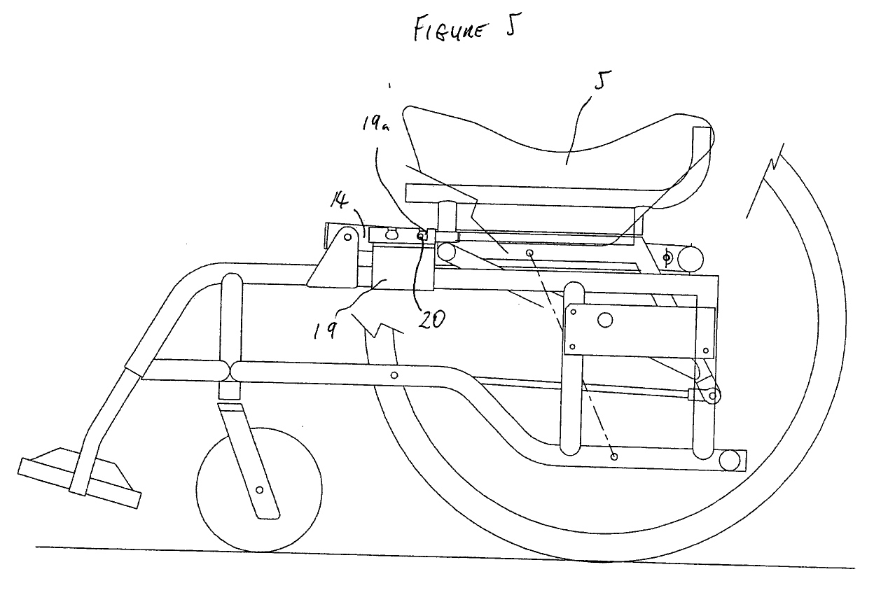

Referring to FIG. 5, a safety lock comprising a plate (19) is attached to the frame (2). The safety lock is configured so that a catch bolt (20) which is attached to the top link (10) will engage with a recessed opening (19a) in the plate (19). With the catch bolt (20) engaged in the recess (19b) of the plate (19) movement of the four bar linkage with respect to the frame (2) due to the action of the gas struts (12) is prevented. When engaged this arrangement prevents the seat from lifting should the catch plate (14) fail to engage properly or the catch plate (14) is accidentally actuated. To prevent lifting of the seat in the event of failure of the catch plate (14), the plate (19) and catch bolt (20) may be attached to any elements of the linkage or frame which move relative to each other.

Further, a safety lock may be provided to lock the seat in the raised position, such a safety lock effectively locking two members of the four bar linkage and/or frame against relative movement.

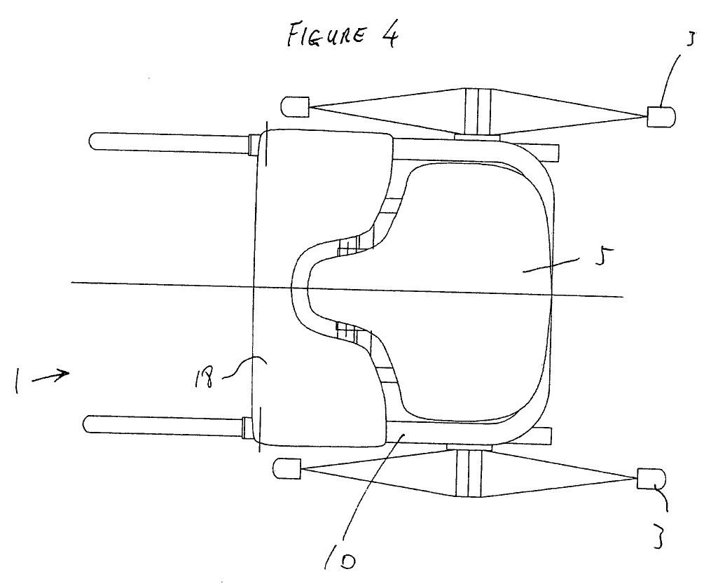

A leg support (18) is attached to the top link (10) so that its surface remains aligned with the orientation of the user when in the seated and raised positions. The height of the leg support (18) relative to the top link (10) may be adjustable. As will be appreciated from FIG. 4, the leg support presents a surface which allows a user of the wheelchair to mount the seat, the user first getting on to the leg support and then, using his arms, lifting himself on to the seat. The leg support illustrated comprises a structure which is attached to the two spaced apart members of the top link 10, extending across the front of and to the sides of the seat 5. In the case of a leg support comprising such a structure, the leg support may be modified such that the front of the saddle seat projects forwardly of the front of the saddle seat, for example a part of the leg support may pass beneath the front part of the saddle seat. The leg support could comprise two separate elements each attached to a respective one of the members of the top link 10. In such a case the leg supports may be located to each side of seat. The leg supports may or may not extend in front of the seat 5.

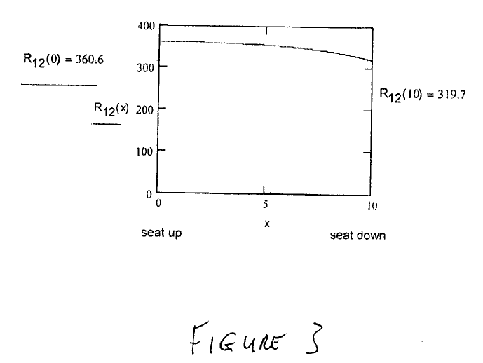

Referring to FIG. 3 this plot is a very shallow curve representing a substantially constant force.

Although the present invention has been described with reference to preferred embodiments, workers skilled in the art will recognize that changes may be made in form and detail without departing from the spirit and scope of the invention.

1. A wheelchair including a frame, a seat and apparatus for moving the seat between lowered and raised positions, the apparatus comprising a translating mechanism having a first end and a second end, wherein the first end of the translating mechanism is attached to the frame and the seat is attached to the second end of the translating mechanism, and wherein the translating mechanism generates a translational movement of the seat that is forwards and upwards with respect to the frame, the apparatus further comprising assist means, wherein the assist means generates a force component substantially parallel to the direction of translation of the seat, to move the seat from the lowered to the raised position, and wherein the seat is a saddle seat and in the lowered position an occupant is in a seated position and in the raised position the occupant is in a mounted stance with a major part of said occupant's weight reacted through the seat, and wherein the translating mechanism comprises a four bar linkage, the seat and the frame being attached to respective ends of the four bar linkage.

2. A wheelchair according to claim 1, wherein one end of the assist means is attached to the frame and the other to an element of the four bar linkage.

3. A wheelchair according to claim 2, wherein one end of the assist means is attached to the top link of the four bar linkage at a point lying substantially equidistant from the respective pivoting ends of the said top link.

4. A wheelchair according to claim 2, further comprising an adjustment means to adjust the effective mounting position of the assist means with respect to at least one of the frame and an element of the four bar linkage.

5. A wheelchair according to claim 4, wherein the said adjustment means includes a plurality of attachment points for attachment of the assist means to at least one of the frame and an element of the four bar linkage.

6. A wheelchair according the claim 4, wherein the adjustment means is provided by an adjuster comprising first and second elements, wherein one of the elements is attached to at least one of the frame and an element of the four bar linkage, and the other element is attached to one end of the assist means, and wherein the relative positions of the first and second elements with respect to each other is adjustable.

7. A wheelchair according to claim 1, wherein the frame is one element of the four bar linkage.

8. A wheelchair according to claim 1, wherein the assist means lies at an angle of between 70 and 105 degrees away from a line extending between the pivot points of the four bar linkage element to which the assist means is attached.

9. A wheelchair according to claim 1, wherein the assist means generates a vertical force component and wherein the vertical force component so generated is greater when the seat is in the raised position than when the seat is in the lowered position.

10. A wheelchair according to claim 1, further comprising a leg support located forward of at least a part of the saddle seat.

11. A wheelchair according to claim 10, wherein the leg support is positioned on the wheelchair such that with the seat in the lowered position a support surface of the said leg support lies in a similar plane to the support surface of the seat.

12. A wheelchair according to claim 10, wherein the leg support is attached to a link of the four bar linkage such that when the seat is in the raised position the support surface of the said leg support is oriented so as to be substantially aligned with the leg of an occupant of the wheelchair in a mounted stance.

13. A wheelchair according to claim 10, wherein the position of the leg support is adjustable.

14. A wheelchair according to claim 1, further comprising a latch mechanism, wherein the said latch mechanism locks the seat in the lowered position when the seat is unoccupied, and wherein unlocking thereof requires a force exerted on the assist means which is greater than the force generated by the assist means.

15. A wheelchair according to claim 14, wherein the latch mechanism comprises a catch plate pivotally mounted on one end of the top link of the four bar linkage, and wherein the surface of the plate is profiled so that as the top link rotates towards the frame the catch plate rotates and engages with a cross-member of the frame to hook over the cross-member when the top link is lowered such that the seat is in its lowered position and restrains further movement of the said top link.

16. A wheelchair according to claim 15, further including a latch release, the latch release comprising a handle connected to the catch plate, wherein movement of the handle in a direction causes rotation of the catch plate away from the frame cross-member.

17. A wheelchair according to claim 1, further comprising a safety lock, wherein the said safety lock when in its locked configuration locks together two elements of the four bar linkage.

18. A wheelchair according to claim 1, further comprising seat suspension means.

19. A wheelchair according to claim 18, wherein the suspension means comprises the four bar linkage, the assist means and the latch mechanism, the said latch mechanism allows for limited downward movement of the four bar linkage, and wherein the assist means resists such downward movement.

20. A wheelchair including a frame, a seat and apparatus for moving the seat between lowered and raised positions, the apparatus comprising a translating mechanism having a first end and a second end, wherein the first end of the translating mechanism is attached to the frame and the seat is attached to the second end of the translating mechanism, and wherein the translating mechanism generates a translational movement of the seat that is forwards and upwards with respect to the frame, the apparatus further comprising assist means, wherein the said assist means generates a force component substantially parallel to the direction of translation of the said seat, to move the seat from the lowered to the raised position, and wherein the seat is a saddle seat and in the lowered position an occupant is in a seated position and in the raised position the occupant is in a mounted stance with a major part of said occupant's weight reacted through the seat, and further including a leg support located forward of at least a part of the saddle seat.

21. A wheelchair according to claim 20, wherein a support surface of the leg support is position on the wheelchair such that with the seat in the lowered position the support surface lies in a similar plane to the support surface of the seat.

22. A wheelchair according to claim 20, wherein the leg support is attached to a link of the four bar linkage such that when the seat is in the raised position the support surface of the said leg support is oriented so as to be substantially aligned with the leg of an occupant of the wheelchair in a mounted stance.

23. A wheelchair according to claim 20, wherein the position of the leg support is adjustable.
